(19) United States
(12) Patent Application Publication
(10) Pub. No.: US 2025/0070110 A1
(43) Pub. Date: Feb. 27, 2025

(54) EFFECTIVE CATHODE ACTIVE MATERIAL COATING TECHNIQUE – DRY COATING

(71) Applicant: Pacific Industrial Development Corporation, Ann Arbor, MI (US)

(72) Inventors: Bing Tan, Ann Arbor, MI (US); John Nodes, Ann Arbor, MI (US); Yuhao Liao, Ann Arbor, MI (US); Luqman Azhari, Ypsilanti, MI (US)

(21) Appl. No.: 18/783,615

(22) Filed: Jul. 25, 2024

Related U.S. Application Data
(60) Provisional application No. 63/533,926, filed on Aug. 22, 2023.

(51) Int. Cl. H01M 4/04; H01M 4/02; H01M 4/36; H01M 4/505; H01M 4/525; H01M 4/58

(52) U.S. Cl. CPC H01M 4/0404; H01M 4/364; H01M 4/505; H01M 4/525; H01M 4/58; H01M 2004/021; H01M 2004/028

(57) ABSTRACT

A process for preparing a coated cathode active material for use in energy storage devices that includes the steps of providing at least one coating material having an average D₅₀ particle size that is in the range of 0.01-1.5 μm; providing one or more cathode active materials; blending the at least one coating material and the one or more cathode active materials with a plurality of milling beads to form a dry mixture, wherein the milling beads have a bead size ranging from 0.1 mm to 2.0 mm; rotating the dry mixture at a speed that is in the range of 50 rpm to 800 rpm for one or more hours to form the coated cathode active material; and separating the coated cathode active material from the milling beads. The coated cathode active material has an average particle size in the range of 2 μm to 30 μm.

### CROSS REFERENCE TO RELATED APPLICATIONS

This application claims the benefit of the filing date under 35 U.S.C. § 119 (e) of U.S. Provisional Application No. 63/533,926 filed on Aug. 22, 2023, the contents of which is incorporated herein by reference in its entirety.

### FIELD

This invention generally relates to a process for coating a cathode active material for use in an energy storage device and to a process of forming an energy storage device that incorporates such a coated cathode active material. More specifically, this disclosure relates to a dry process for applying a coating onto a cathode active material.

### BACKGROUND

The statements in this section merely provide background information related to the present disclosure and may not constitute prior art.

The cathode active materials that are predominantly utilized in batteries for electric vehicles (EV) include one or more of nickel-rich NCA (nickel-cobalt-aluminum), NCM (nickel-cobalt-manganese), or NCMA (nickel-cobalt-manganese-aluminum) and LiFePO₄ (LFP). Nickel-rich NCA, NCM, and NCMA (also referred to as NCA/NCM/NCMA when used alone or in combination) provide for high energy density and decent power capabilities at a reasonable cost. However, these materials also inherently come with an intrinsically high risk related to poor thermal stability due to their ability to release oxygen at high temperatures. Thus, the energy density provided in a battery pack is limited because the incorporation of more inactive materials is necessary in order to ensure that the EV can pass government safety regulations.

The thermal stability of a nickel-rich cathode material (NCA/NCM/NCMA) may be enhanced by mixing or blending it with a phosphate active material, such as LiFePO₄ (LFP), LiFeₓMn₁₋ₓPO₄ (0<x<1, LFMP), LiMnPO₄ (LMP), and/or LiVOPO₄. Compared to NCA/NCM/NCMA, a phosphate-active material provides superior thermal stability, lower cost, and lower, but acceptable energy density. A nickel-rich cathode material mixed with a phosphate-active material may provide a cathode active system that exhibits improved thermal stability, while maintaining high energy density and low cost. For example, a 2 Ah NCM523/graphite cell can catch on fire upon nail penetration, while when 20% of LFP or 30% of LFMP is mixed therewith, the cell will not catch on fire but only swell. A similar safety improvement has also been observed when using LFP mixed with NCM622.

Compared to mixed or blended materials, LFP or LFMP coated onto NCA/NCM/NCMA may provide better thermal stability since more LFP/LFMP particles will be active and less surface area of the NCA/NCM/NCMA particles will be exposed to the electrolyte. The presence of an LFP/LFMP coating layer may also be able to remove oxygen (O₂) molecules released from NCA/NCM/NCMA and prevent these molecules from diffusing into the anode side of the energy storage device and fueling the generation of heat.

You et al. in RSC Adv., 2020 (10), 37916 reported that NCM622 coated with 10 wt. % LFP using a high energy, planetary ball-milling process over a four hour period enhanced the cycling stability of the cathode active material at high temperature and delayed the occurrence of an exothermic peak. Similarly, Zhu et al. in the Journal of The Electrochemical Society, 2019 (166), A5437 used a high speed dispersion and mechanical fusion machine (Wuxi Fuan Powder Equipment Co., Ltd., China) to coat LFP onto NCM at 400 revolutions/minute over a period of 15 minutes. These coated NCM/MCMB cells did not exhibit any fire/explosion upon nail penetration, while the un-coated NCM/NCMB caught fire instantly. Finally, Zhong et al. in the Journal of Power Sources, 2020 (464), 228235 prepared 5% of LFP coated onto NCM by mixing them together in a mechanical fusion machine (Wu Xi Xinguang Powder Equipment Co., Ltd., China) for 10 min at a speed of 2,000 rpm. A 6° C. delay of the on-set temperature of thermal runaway was observed upon incorporation of 5 wt. % of LFP coating onto NCM. Thus, the incorporation of an LFP coating improves the thermal stability of NCM when such coatings are achieved by mixing the LFP and NCM through the use of either a planetary ball mill or high-speed mechanical fusion process. However, as Zhong noted the loading of LFP onto the NCM must be limited to 10 wt. % or less in order to ensure a uniform coating.

In commercial use, it is desirable to be able to apply greater than 10 wt. % of an LFP-type coating in order to achieve better thermal stability and meet the safety requirements necessary for use in electric vehicles. In addition, both planetary milling and high-speed mechanical fusion represent high energy milling/mixing processes, which are difficult to scale-up on an industrial scale when tons of materials need to be produced. In order to be commercially feasible, a lower or more moderate energy process is necessary in order to reduce the production cost and simplify scale-up.

### SUMMARY

The present disclosure relates to a process for preparing a cathode active material for use in an energy storage device. This process generally comprises: providing at least one coating material; providing one or more cathode active materials; blending the at least one coating material and the one or more cathode active materials with a plurality of milling beads to form a dry mixture; rotating the dry mixture at a speed that is in the range of 50 rpm to 800 rpm for one or more hours to form a coated cathode active material; and separating the coated cathode active material from the milling beads. Alternatively, the speed at which the mixture is rotated ranges from 200 rpm to 300 rpm for a period of time that is in the range from 1 hour to 48 hours.

The coated cathode active material may comprise between 0.1% and 50% by mass of the coating material; alternatively, between 10% and 20% by mass of the coating material. The coated cathode active material formed by this process may have an average particle size in the range of 2 μm to 30 μm; alternatively, an average particle size in the range of 5 μm to 20 μm.

The coating material has an average D₅₀ particle size that is in the range of 0.01 μm to 1.5 μm; alternatively, in the range of 0.05 μm to 1.5 μm; alternatively, in the range of 0.2 μm to 0.5 μm. The cathode active material may comprise spherical-like secondary particles.

The cathode active material may be selected from the group consisting of LiMn₂O₄, LiCoO₂, LiNiO₂, and LiNiO₂-based materials. Alternatively, the cathode active material may be selected from the group consisting of NCM523, NCM622, NCM712, NCM811, NCA, NCMA, and NCM90505.

The at least one coating material may be an electrochemically inert material, the electrochemically inert material being comprised of carbon, an ionic conductive material, or a mixture thereof. Alternatively, the at least one coating material is an electrochemically active material. This electrochemically active material may be a phosphate-active material, selected from the group consisting of LifePO₄ (LFP), LiFeₓMn₁₋ₓPO₄ (0<x<1, LFMP), LiMnPO₄ (LMP), and LiVOPO₄.

The plurality of milling beads may comprise stainless steel, ZrO₂, modified ZrO₂, or a mixture thereof. These milling beads may have a bead size ranging from 0.1 mm to 2.0 mm; alternatively, an average particle size ranging from 0.5 mm to 1.0 mm.

According to another aspect of the present disclosure, a process of forming an energy storage device that incorporates such a coated cathode active material is provided. The process for forming an energy storage device generally comprises: a) providing at least one coating material that has an average D₅₀ particle size in the range of 0.01 μm to 1.5 μm; b) providing one or more cathode active materials; c) blending the at least one coating material and the one or more cathode active materials with a plurality of milling beads having a bead size ranging from 0.1 mm to 2.0 mm to form a dry mixture that comprises 0.1 wt. % to 10 wt. % of the at least one coating material with respect to the combined weight of the at least one coating material and the one or more cathode active materials; d) rotating the dry mixture at a speed that is in the range of 50 rpm to 800 rpm for one or more hours to form an initial coating on cathode active material; e) blending an additional predetermined amount of coating material into the dry mixture to form a concentrated dry mixture; f) repeating step d) with the concentrated dry mixture to form a coated cathode active material comprising >10 wt. % coating material relative to the overall weight of the coated cathode active material; and g) separating the coated cathode active material from the milling beads.

The coated cathode active material formed in this process may have an average particle size in the range of 2 μm to 30 μm. The least one coating material is an electrochemically inert material comprised of carbon, an ionic conductive material, or a mixture thereof or the at least one coating material is an electrochemically active material comprised of a phosphate-active material selected from the group consisting of LifePO₄ (LFP), LiFeₓMn₁₋ₓPO₄ (0<x<1, LFMP), LiMnPO₄ (LMP), and LiVOPO₄.

In addition, when necessary or desirable, one or more of the following is present:
the cathode active material is selected from the group consisting of LiMn₂O₄, LiCoO₂, LiNiO₂, and LiNiO₂-based materials;
the cathode active material is selected from the group consisting of NCM523, NCM622, NCM712, NCM811, NCA, NCMA, and NCM90505;
the coated cathode active material comprises spherical-like secondary particles; and
the plurality of milling beads comprise stainless steel, ZrO₂, modified ZrO₂, or a mixture thereof.

The process for forming an energy storage device may also be described according to the following steps: preparing a coated cathode active material using a dry coating process according to the teachings of the present disclosure; and incorporating the coated cathode active material into the energy storage device.

Further areas of applicability will become apparent from the description provided herein. It should be understood that the description and specific examples are intended for purposes of illustration only and are not intended to limit the scope of the present disclosure.

### DESCRIPTION OF THE DRAWINGS

In order that the disclosure may be well understood, there will now be described various forms thereof, given by way of example, reference being made to the accompanying drawings. The elements in each of the drawings may not necessarily be drawn to scale, but rather emphasis is placed upon illustrating the principles of the invention.

FIG. 1 is a flowchart depicting a dry milling or coating process of applying a coating material to the surface of cathode active material according to the teachings of the present disclosure.

FIG. 2 is a flowchart demonstrating a further modification to the dry milling or coating process according to the teachings of the present disclosure.

FIG. 3A represents scanning electron micrographs at various magnification levels that show a blend of a coating material and a cathode active material prior to dry coating and after dry coating in the absence of any milling beads.

FIG. 3B represents scanning electron micrographs at various magnification levels that show the blend of the coating material and the cathode active material of FIG. 3A after milling in the presence of 0.5 mm, 1 mm, or 2 mm beads.

FIG. 4A represents scanning electron micrographs at various magnification levels that show a blend of another coating material and a cathode active material prior to dry coating and after dry coating in the absence of any milling beads.

FIG. 4B represents scanning electron micrographs at various magnification levels that show the blend of the coating material and the cathode active material of FIG. 4A after milling in the presence of 0.5 mm, 1 mm, or 2 mm beads.

FIG. 5 represents scanning electron micrographs at various magnification levels that show a blend of another coating material and another cathode active material that has been subjected to dry coating according to the teachings of the present disclosure.

FIG. 6 represents scanning electron micrographs at various magnification levels that show a blend of yet another coating material and another cathode active material that has been subjected to dry coating according to the teachings of the present disclosure.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. For example, the coated cathode active materials comprising one or more electrochemically inert materials or electrochemically active materials as a coating applied to a cathode active material made and used according to the teachings contained herein are described throughout the present disclosure in relation to a secondary cell of a lithium-ion secondary battery in order to more fully illustrate the structural elements and the use thereof. The incorporation and use of such coated cathode active materials in other applications, including without limitation, in any electrochemical cell or in a primary cell for a lithium-ion battery, is contemplated to be within the scope of the present disclosure. It should be understood that throughout the description and drawings, corresponding reference numerals indicate like or corresponding parts and features.

For the purpose of this disclosure, the terms “about” and “substantially” are used herein with respect to measurable values and ranges due to expected variations known to those skilled in the art (e.g., limitations and variability in measurements).

For the purpose of this disclosure, the terms “at least one” and “one or more of” an element are used interchangeably and may have the same meaning. These terms, which refer to the inclusion of a single element or a plurality of the elements, may also be represented by the suffix “(s)” at the end of the element. For example, “at least one coating material”, “one or more coating materials”, and “coating material(s)” may be used interchangeably and are intended to have the same meaning.

The present disclosure generally describes a dry coating process that uses a low to moderate mill capable of applying a phosphate-active material as a coating onto a cathode active material, such as NCA/NCM/NCMA. Compared to conventional processes that utilize planetary ball mills and high-speed mechanical fusion machines, a low or moderate energy mill, such as one that includes roller jar milling or the like, are much more economical and simpler to scale-up in an industrial setting. In addition, high-energy mills require more robust containers to stand-up to the elevated crushing forces arising from the milled media, as well as more robust machine designs in order to apply and handle the high energy rolls that are utilized.

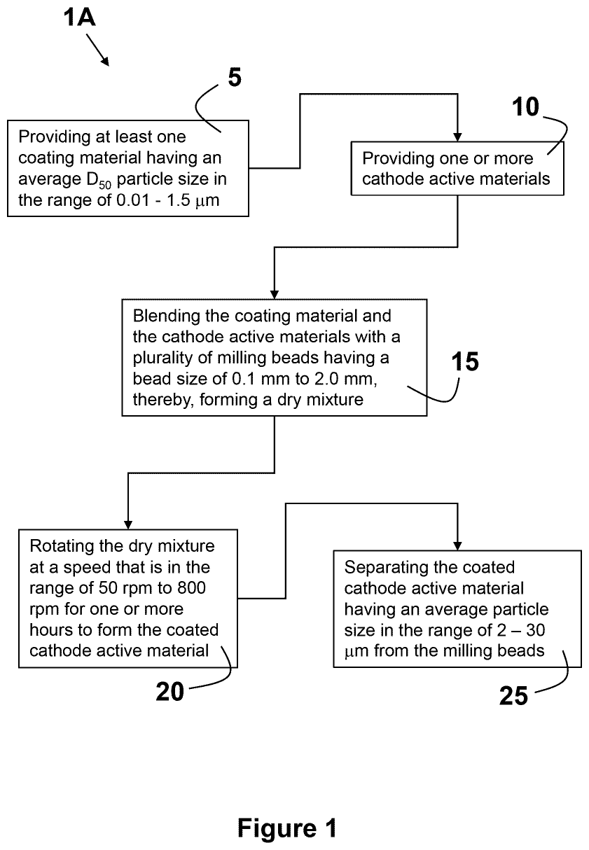

Referring now to FIG. 1, the dry coating process 1A, generally comprises providing 5 at least one coating having an average D₅₀ particle size in the range of 0.01-1.5 μm and providing 10 one or more cathode active materials. The coating material and the cathode active materials are blended 15 with a plurality of milling beads that have a bead size of 0.1 mm to 2.0 mm in order to form a dry mixture. The dry mixture is rotated 20 at a speed that is in the range of 50 rpm to 800 rpm for one or more hours to form the coated cathode active material. Finally, the coated cathode material, which has an average particle size in the range of 2-30 μm, is separated 25 from the milling beads.

By controlling the particle size of the coating materials and the milling bead size, a coating may be applied onto a cathode active material at various loadings ranging from 5 wt. % to wt. %; alternatively, >10 wt. %; alternatively, ≥15 wt. % relative to the weight or mass of the coated cathode active material with uniform coating coverage at low/moderate milling speeds. This dry coating process 1A may be used to apply a coating to a cathode active material with at least 30 wt. % of the coating mass loading when desired. Thus, the dry coating process 1 of the present disclosure substantially enhances the maximum amount of coating of ≤10 wt. % achievable with conventional high energy processes.

Referring now to FIG. 1B, the amount of coating applied to the cathode active material is increased upon utilization of a dry coating process 1B that generally comprises providing 5 at least one coating having an average D₅₀ particle size in the range of 0.01-1.5 μm and providing 10 one or more cathode active materials. The coating material and the cathode active materials are blended 15 with a plurality of milling beads that have a bead size of 0.1 mm to 2.0 mm in order to form a dry mixture comprising 0.1 wt. % to 10 wt. % of the coating material relative to the overall weight or mass of the coating material and the cathode active material. The dry mixture is rotated 20 at a speed that is in the range of 50 rpm to 800 rpm for one or more hours to form an initial coating on the cathode active material. Then, an additional predetermined amount of the coating material is blended 30 with the dry mixture comprising the initially coated cathode active material to form a concentrated dry mixture. The concentrated dry mixture is rotated 35 at a speed that is in the range of 50 rpm to 800 rpm for one or more hours to form the coated cathode material comprising >10 wt. % coating material relative the weight or mass of the coating material and the cathode active material. When desirable, the step(s) of incorporating additional coating material may be performed any additional number of times without exceeding the scope of the present disclosure. Finally, the coated cathode material, which has an average particle size in the range of 2-30 μm, is separated 25 from the milling beads.

In the process 1A, 1B, a coating material, e.g., a phosphate-active material, is jar-milled with a cathode active material, e.g., NCA/NCM/NCMA, in the presence of beads wherein the particle size of the coating material and the size of beads are predetermined. The selection of the particle size of the phosphate-active material and the bead sizes represent a critical aspect of the process that is necessary for achieving a uniform coating on the cathode active material.

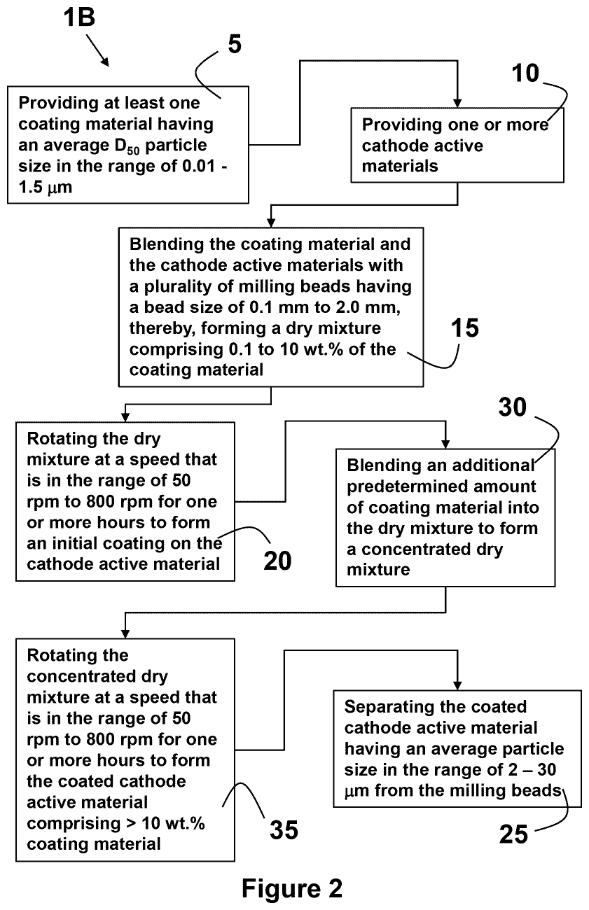

Still referring to FIGS. 1 and 2, the dry coating process 1 to prepare coated cathode active materials, includes mixing 15 of the coating material, the cathode active material, and the milling media in a container, followed by rotating 20 the container or jar at a slow to moderate speed. The coating material may be an electrochemically inert material or an electrochemical active material. The electrochemically inert material may include an electric conductive material, such as a carbonate material selected from, but not limited to, carbon black, graphene, and amorphous carbon. The electrochemically inert materials may also include an ionic conductive material, including without limitation, lithium lanthanum zirconium oxide (LLZO), Li₄Ti₅O₁₂, AlPO₄, and LiTi₂(PO₄)₃, to name a few. Due to the electrochemical inactive nature of these “inert” materials, the coating loading applied to the cathode active material may be limited to 5 wt. % or less relative to the overall weight of the coated cathode active material in order to avoid the significant loss of the reversible energy density of the coated cathode active material.

The coating material is preferred to be an electrochemically active material, which may act as a cathode active material if the coating material was used alone. In this case, a higher coating loading may be applied to a cathode active material. According to one aspect of the present disclosure, the electrochemically active coating material is a phosphate active material including, without limitation, LiFePO₄ (LFP), LiFeₓMn₁₋ₓPO₄ (0<x<1, LFMP), LiMnPO₄ (LMP), LiVOPO₄, and LiCoPO₄, (LCP) to name a few.

The coating materials may comprise nanometer-sized primary particles that are coated with carbon. The coating materials are selected such that they provide for acceptable ionic conductivity, electric conductivity, and energy density. As a coating material, its average (D₅₀) particle size and overall particle size range is preferred to be small, so that a dense coating layer may be easier to achieve on the surface of the cathode active material. The average (D₅₀) particle size for the coating material, e.g., phosphate active material, may be in the range from 0.01 micrometers (μm) to 1.5 micrometers (μm), alternatively, from about 0.05 μm to 1 μm, alternatively, from 0.1 μm to 0.8 μm, alternatively, 0.2 μm to 0.8 μm, or alternatively, from 0.2 μm to 0.5 μm. In general, the narrowest range was found to be preferred.

The use of a coating material having an average (D₅₀) particle size in excess of 1.5 was found to be very challenging with respect to providing a uniform coating on a cathode active material. In addition, it is also found to be extremely difficult and costly to prepare a dry powder of a phosphate active material that exhibits an average (D₅₀) particle size of <0.01 μm. One skilled in the art will understand that it may be possible to include a portion of larger secondary particles, e.g., with sizes>1.6 μm, of the coating material without exceeding the scope of the present disclosure provided that these secondary particles can be milled down by the milling beads to less than 1.5 μm average size of the primary particles of the coating material that are used in the dry coating process. In this situation, the large secondary particles of coating material will need to be more fragile than the cathode active materials so that the milling beads can break down the micro-sized secondary particles of the coating material, but not the micro-scaled particles of the cathode active material.

As for the choice of the material to be coated in the dry coating process, it is expected to be a cathode active material that may exhibit poor stability in an electrolyte. One example of such a cathode active material is LiMn₂O₄, which is not chemically stable in an acidic carbonate electrolyte with LiPF6 salt because of manganese (Mn) dissolution. Several other examples of cathode active materials include, but are not limited to, LiCoO₂, LiNiO₂, LiFePO₄ (LFP), and nickel-rich NCA (nickel-cobalt-aluminum), NCM (nickel-cobalt-manganese), or NCMA (nickel-cobalt-manganese-aluminum) with various nickel contents. Nickel-rich NCA, NCM, and NCMA may also referred to as NCA/NCM/NCMA when used alone or in combination). The NCA/NCM/NCMA cathode active material may be selected from, without limitation, NCM523, NCM622, NCM712, NCM811, NCA, NCMA, and NCM90505, to name a few. Each of these Co-based and Ni-based cathode active materials are well known for their poor thermal stability in an electrolyte. Thus, the application of a thermally stable coating on to the surface of these cathode active materials will help improve the thermal stability of these materials.

Since the cathode active material represents the material to be coated, it is desirable that it exhibit an average (D₅₀) particle size that is larger than the average (D₅₀) particle size of the coating material. Typically, the average (D₅₀) particle size of the Mn-based, Co-based, or Ni-based cathode active materials is in the range of 2 μm to 30 μm, alternatively, from 3 μm to 25 μm, and alternatively, from 5 μm to 20 μm. The cathode materials are generally prepared with a co-precipitation process or a spray drying process to form spherical-like particles. One skilled in the art understands that it is very challenging to make particles of the cathode active materials that exhibit an average (D₅₀) particle size of <2 μm. The average (D₅₀) particle size associated with the upper limit is typically limited to ≤30 μm in order to ensure acceptable power capability exhibited by the cathode electrode formed with the cathode active material for use in lithium-ion batteries. The skilled person will understand that the dry coating process of the present disclosure may be used to coat cathode active material having an average (D₅₀) particle size >30 μm when desirable without exceeding the scope of the present disclosure.

The spherical-like particle shape of the cathode active material is desirable in order to achieve a high packing electrode density. However, the dry coating process of the present disclosure may be used to apply a coating material to the surface of particles formed of cathode active materials that exhibit other shapes or morphology.

The milling media is expected to be a hard bead that can be smoothly rolled inside a container, e.g., a jar, and withstand the forces encountered by impacts that occur between the particles of the coating material, the particles of the cathode active material, other beads, and the container, without breaking. Several examples of such hard beads, include, but are not limited to, stainless steel and zirconia beads with zirconia-based beads being preferred. These hard beads may have an average (D₅₀) particle size ranging from 0.1 mm to 2.0 mm, alternatively, from 0.2 mm to 1.5 mm, alternatively, 0.2 mm to 2.0 mm, alternatively, from 0.5 mm to 1.0 mm; and alternatively, from 0.6 mm to 0.9 mm.

In the dry coating process of the present disclosure, the mass ratio of the loading in the container between the beads and the milling materials (i.e., coating material and cathode active material) is in the range of 1:99 to 99:1, alternatively, between 10:1 to 1:10, and alternatively, in the range of 5:1 to 1:1. In conventional processes, such as a high energy mill, including a planetary mill, the hard beads may easily break the particles of the cathode active material. However, in the dry coating process of the present disclosure, the hard beads assist in pulverizing the particles of the coating material, but not the particles of the cathode active material.

In the dry coating process, it is important to tune the size of the milling beads based on the rotational speed of the container. The rotational speed of a jar mill is typically on the order of ≤300 rpm and the corresponding bead size may be up to about 1 mm-2 mm; alternatively between 1 mm and 1.5 mm; alternatively, about 1 mm without affecting the particle size of cathode active materials. In the absence of milling beads, the impact force that occurs between the particles of the cathode active material will not be high enough to mechanically fuse the smaller particles of the coating material onto the larger particles of the cathode active material. The coating material preferably exhibits a small average particle size, so that it is easier to be coated onto the cathode active material particles with a uniform coating layer.

The rotational speed of the milling machine may be selected to range from 10 rpm to 800 rpm, alternatively, from 100 rpm to 400 rpm, alternatively, from about 200 rpm to 300 rpm. The optimal size of the milling bead used in the dry coating process of the present disclosure is related to the selected rotational speed. The higher the speed, the smaller the size of the milling beads used. For example, milling beads with 2 mm size may work well with 100 rpm, but it will break the cathode active material particles having an average (D₅₀) particle size of 15 μm into smaller particles at 300 rpm. The actual bead size and rotational speed used in the dry coating process is predetermined in order to optimize with the application of a uniform coating on to the cathode active material particles.

In terms of the milling time, it is preferred to be relatively long because the milling process is a low/moderate energy process. The dry coating process of the present disclosure requires time to mechanically fuse the small particles of the coating material onto the larger particles of the cathode active material in order to form a coated cathode active material. The milling time is on the order of one or more hours. Since milling for a long time will reduce the production rate and increase the cost, it is therefore preferred to be no longer than 48 hours; alternatively, less than or equal to 24 hours; alternatively, in the range of 2 hours to 36 hours; alternatively, 8 hours to 22 hours, alternatively, 10 hours to 18 hours.

The amount of the coating material applied to the surface of the cathode active material is expected to be on the order of 0.1 wt. % to 50 wt. %, alternatively, from 1 wt. % to 30 wt. %, alternatively, from 5 wt. to 20 wt. %, alternatively, at least greater than 10 wt. %, alternatively, between 11 wt. % and about 30 wt. %; alternatively, 11 wt. % to 20 wt. %.

The specific examples provided in this disclosure are given to illustrate various embodiments of the invention and should not be construed to limit the scope of the disclosure. The embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

Scanning electron microscopy (SEM) or other optical or digital imaging methodology known in the art may be used to determine the shape and/or morphology of the cathode active materials and the coating materials before and after being blended together in the dry coating process, as well as the coated cathode active materials resulting from the dry coating process. The average particle size and particle size distributions may be measured using any conventional technique, such as sieving, microscopy, Coulter counting, dynamic light scattering, or particle imaging analysis, to name a few. Alternatively, a laser particle analyzer is used for the determination of average particle size and its corresponding particle size distribution.

### Example 1—Preparing Coated Cathode Active Materials (Run No.'s R-1, R-2, & R-3 Along with Comparative Run No. C-1)

According to one aspect of the present disclosure, a mixture of commercially available polycrystalline Ni-rich LiNi_{0.8}Co_{0.1}Mn_{0.1}O₂ (NCM811) as the cathode active material and commercially available LiFePO₄ (LFP) as the coating material were dry milled with and without zirconia beads. The average (D₅₀) particle size of the commercially available NCM811 is >10 μm, while the commercial LFP has an average (D₅₀) particle size of about 0.9 μm. Three difference bead sizes, namely, about 0.5 mm, about 1 mm, and about 2 mm are used in separate examples R-1, R-2, and R-3, respectively. In comparative example C-1, no beads were used during the dry milling or coating procedure.

More specifically, 0.375 grams of LFP (Gelon) and 5.0 grams of NCM811 were blended in a plastic bottle without beads or with 16 grams of zirconia beads in the various sizes (0.5 mm, 1 mm, or 2 mm). The plastic bottle was placed on a jar roller (US stoneware) and rolled at about 200 rpm to 300 rpm for 24 hours. The coated cathode active material was then separated from the milling media.

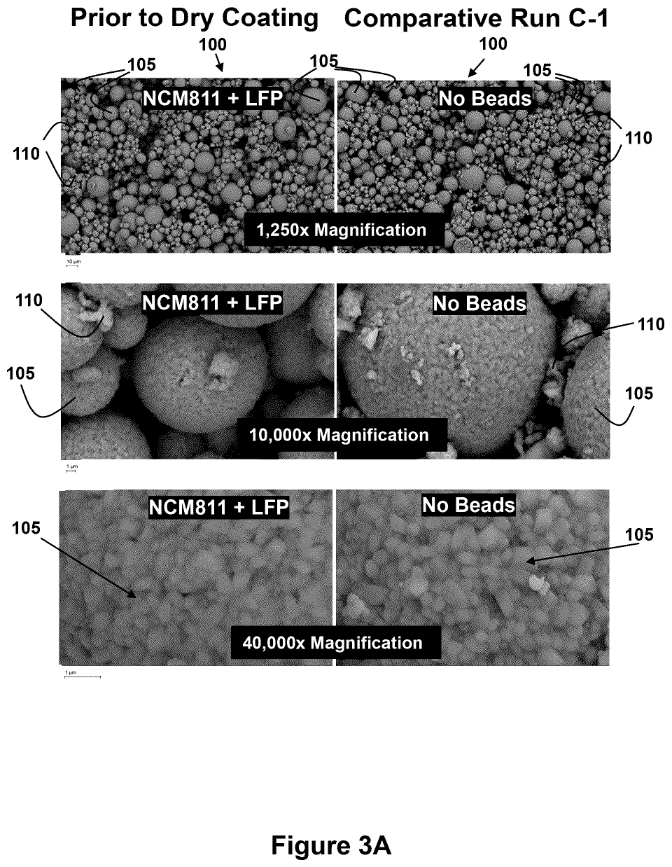

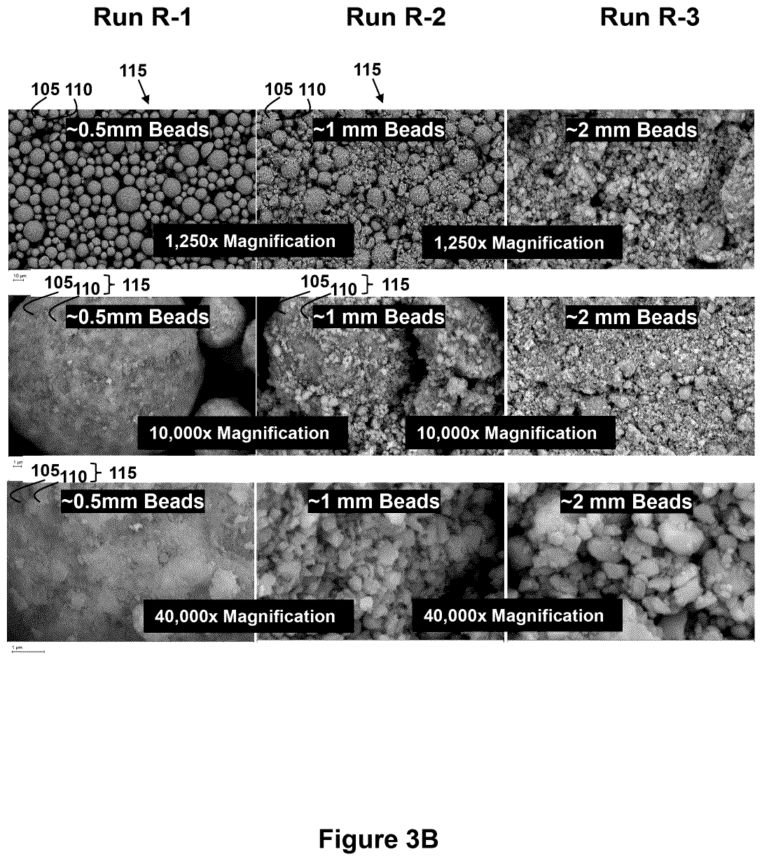

Referring now to FIG. 3A, scanning electron microscopy (SEM) micrographs demonstrate the structure of the blend 100 formed by mixing the NCM811 105 and LFP 110 together, prior to proceeding with the dry coating process (e.g., prior to dry milling) and also the result of proceeding with the dry coating process in the absence of or without the incorporation of any milling beads (Comparative Run C-1). In FIG. 3B, the SEM micrographs depict the results of the dry coating process applied to the blend shown in FIG. 3A using 0.5 mm (Run R-1), 1.0 mm (Run R-2), and 2.0 mm (Run R-3) diameter milling beads. In both FIGS. 3A and 3B, the SEM micrographs are shown using three levels of magnification, 1,250×, 10,000×, and 40,000×.

Still referring to FIGS. 3A & 3B, the commercially available NCM811 cathode active material 105 exhibited spherical-like particle shapes that ranged in diameter from nanometers up to several micrometers. In each of the Runs 1-3 and C-1, there were dense-packed primary particles of the NCM811 105 with the sizes <400 nm. The nano-size ranged particles were expected for the polycrystalline NCM particles 105. When dry milled without any zirconia beads (Run C-1), these nano-size primary particles 105 were still clearly observed with boundaries present between the particles 105.

When the blend was milled with ˜0.5 mm beads (Run-1), the previously observed nano-sized primary particles 105 of NCM811 disappeared. Instead, the surface of the NCM811 particles 105 was covered with a dense coating layer of LFP 110, thereby forming the coated cathode active material 115. Boundaries between the coated cathode active particles 115 were observed and the large spherical-like shapes from the NCM811 particles 105 were still preserved.

When the blend was milled with either ˜1 mm beads or ˜2 mm beads, the coated cathode active particles 115 were broken, the boundaries between the coated cathode active particles diminished and the large spherical-like shape of the large spherical-like NCM811 particles 105 disappeared. These experimental runs demonstrate that the presence of beads are needed for dry coating (see comparison of Run C-1 with Runs 1-3). It is also important that the right bead sizes are selected in order to optimize the formation of the LFP coating on the NCM811 particles while maintaining boundaries between and the spherical-shape of the coated cathode active particles 115. In conventional processes described in the existing art, the presence or type of beads is not described, nor is the size of beads found to be critical.

### Example 2—Preparing Coated Cathode Active Materials (Run No.'s R-4, R-5, & R-6 Along with Comparative Run No. C-2)

According to one aspect of the present disclosure, a mixture of Ni-rich LiNi_{0.8}Co_{0.1}Mn_{0.1}O₂ (NCM811) as the cathode active material and pre-milled LiFePO₄ (LFP) as the coating material were dry milled with and without zirconia beads. The pre-milled LFP was prepared by milling the commercially available LFP described in Example 1 via a high energy wet milling process. The pre-milled LFP exhibited an average (D₅₀) particle size of about 0.4 to 0.5 μm as compared to ˜0.9 μm measured for the commercially available LFP in Example 1.

More specifically, 0.375 grams of LFP (pre-milled) and 5.0 grams of NCM811 were blended in a plastic bottle without beads or with 16 grams of zirconia beads in the various sizes (0.5 mm, 1 mm, 2 mm). The plastic bottle was placed on a jar roller (US stoneware) and rolled at ˜ 200-300 rpm for 24 hours. The pre-milled LFP was prepared using a high energy wet milling process comprising a Eiger Mill operated at 2,000 rpm for 1 hour to 4 hours. The wet milled LFP was then dried in an oven before use in the coating process.

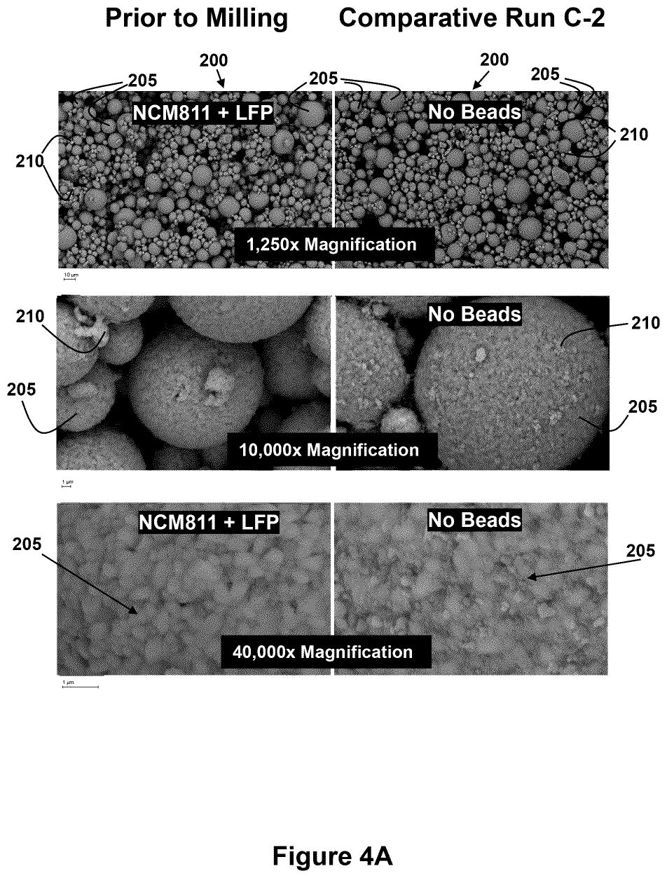

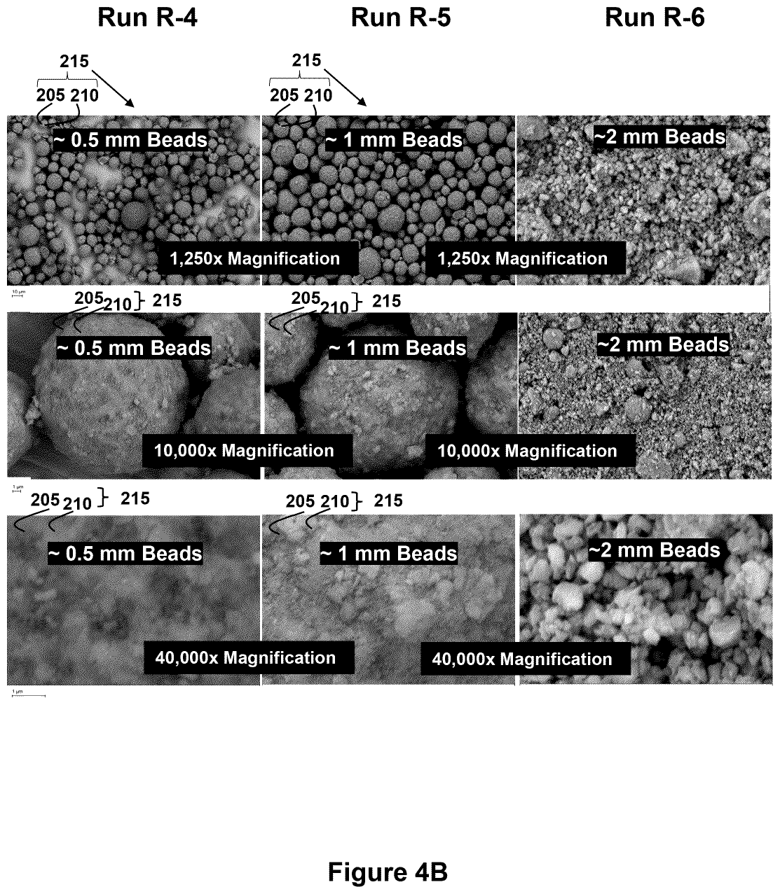

Referring now to FIG. 4A, scanning electron microscopy (SEM) micrographs demonstrate the structure of the blend 200 formed by mixing the NCM811 205 and pre-milled LFP 210 together, prior to proceeding with the dry coating process (e.g., prior to dry milling) and also the result of proceeding with the dry coating process in the absence of or without the incorporation of any milling beads (Comparative Run C-2). In FIG. 4B, the SEM micrographs depict the results of the dry coating process applied to the blend shown in FIG. 4A using 0.5 mm (Run R-4), 1.0 mm (Run R-5), and 2.0 mm (Run R-6) diameter milling beads. In both FIGS. 4A and 4B, the SEM micrographs are shown using three levels of magnification, 1,250×, 10,000×, and 40,000×.

Still referring to FIGS. 4A & 4B, the commercially available NCM811 cathode active material 205 exhibited spherical-like particle shapes that ranged in diameter from nanometers up to several micrometers. In each of the Runs 4-6 and C-2, there were dense-packed primary particles of the NCM811 205 with the sizes <400 nm. The nano-size ranged particles were expected for the polycrystalline NCM particles 205. When dry milled without any zirconia beads (Run C-2), the nano-size primary particles 205 were still clearly observed with boundaries observable between the particles 205. However, when the blend 200 was milled without any beads being present, the NCM811 spherical-like particles 205 appeared to attract some small LFP particles 210, most likely due to the attractive forces that exist between the small average particle size of the pre-milled LFP particles 210 and the surface of the larger NCM811 205 particles. Although the boundaries between the NCM811 primary particles 205 remained intact, these boundaries became slightly blurred by the attraction of the small LFP particles 210 to the surface of the primary particles 205. A comparison between the blends 100, 200 milled in the absence of beads in Run C-1 (see FIG. 3A) using the larger commercially available LFP particles 110 and in Run C-2 (see FIG. 4A) using the smaller pre-milled LFP particles 210 demonstrates that the smaller LFP particles 210 are more easily attracted to the surface of the spherical-like NCM811 particles 105, 205.

When the blend is milled with ˜0.5 mm beads, the boundaries between the NCM811 primary particles 205 were not identifiable, but rather the spherical-like particles 205 were covered with a dense coating of LFP particles 210, thereby forming the coated cathode active particles 215. When the blend is milled with ˜1 mm beads, the milled material again showed good LFP particle 210 coating coverage on each spherical-like large NCM811 particle 205 demonstrating the formation of the coated cathode active particles 215. In this Example 2, unlike the dry milling with commercially available LFP conducted in Example 1 (see FIG. 3B), the large spherical-like particles of the NCM811 were not broken even with ˜ 1 mm beads in the presence of the pre-milled LFP. Although not wanting to be held to theory, these different results may come from slight differences in the rotation speeds utilized for the milling of the blends 100, 200 in Runs 3 and 6 as shown in FIGS. 3A and 4A. Thus, beads with ˜ 1 mm sizes may be close to the maximum beads sizes that can be used in the dry coating or milling process without damaging the NCM811 particles 105, 205. When the blend is milled with ˜2 mm beads, almost all the spherical-like particles 205 were crushed with no spherical particles being observed by Scanning Electron Microscopy.

This Example 2 demonstrates that for low to moderate energy milling, it is important to control both the particles size of the coating material (e.g., the LFP) and the size of the milling beads in order to achieve a uniform coating without damaging the cathode active material particles. A coating material, e.g., LFP, with a smaller average (D₅₀) particle size will be easier to coat onto the larger cathode active particles, e.g., NCM811, since the surface energy of the particles is higher for smaller particles. As for the beads, their size is important in order to fuse the smaller coating material particles onto larger cathode active material particles by generating an impact force that is high enough to fuse the coating material to the surface of the cathode active material particles. Alternatively, the coating material is fused to the surface of the cathode active materials to form a uniform coating layer. However, the size of the beads, cannot be too large, otherwise the crushing force arising from impacts with the coating material and the cathode active material will be too strong and able to break the cathode active particles.

### Example 3—Preparing Coated Cathode Active Materials (Run No. R-7)

According to one aspect of the present disclosure, 0.376 grams of LiFeₓMn₁₋ₓPO₄ (0<x<1, LFMP) jet-milled to an average (D₉₀) particle size in the range of 0.5 to 0.9 mm and 5.0 grams of commercially available LiNi_{0.9}Co_{0.05}Mn0.05O₂ or NCM90505 (Gelon) were blended in a plastic bottle with 16 grams of 0.8 mm particle size yttria stabilized zirconia (YSZ) beads. The mixture was rolled on the jar roller (US stoneware) at 200-300 rpm for about 12 hours.

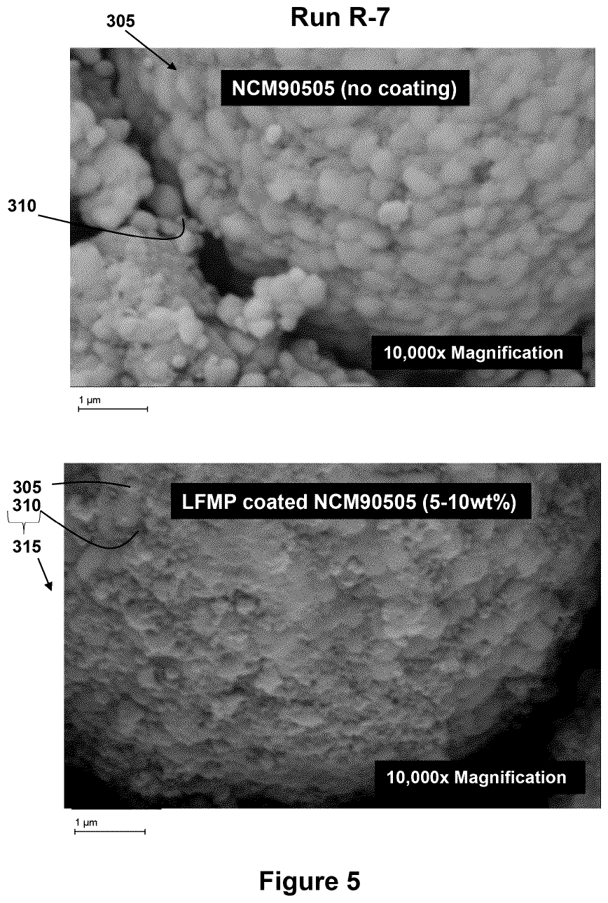

Referring now to FIG. 5, similar to Examples 1 and 2, the LFMP 310 was found to be capable of being coated onto the cathode active material particles 305 in Run-7 without damaging the spherical-like shape of the cathode active material particles 305. The LFMP coating 310 was found to be relatively uniform across the surface of the NCM particles 305, thereby, forming the cathode active material particles 315. The amount of coating material present in the coated cathode active material 315 is between 5 wt. % to 10 wt. % relative to the overall weight of the coated cathode active material particles 315. This example demonstrates acceptable dry coating using different cathode active materials and coating materials.

Still referring to FIG. 5, the reported amount of the coating material in a conventional process is limited to about ≤10 wt. % in order to achieve a uniform coating of cathode active material particles. However, in the dry coating or milling process of the present disclosure, a much higher coating loading is possible.

### Example 4—Preparing Coated Cathode Active Materials (Run No. R-8)

According to one aspect of the present disclosure, coated cathode active material particles were obtained that comprised >10 wt. %, alternatively, ≥15 wt. % loading of the coating material by performing multiple successive applications and/or continual operation of the dry coating process. More specifically, LFMP (as previously described) was used as a coating material with NCM811 (as previously described) as the cathode active material particles. The dry coating process was conducted according to the previous Examples with the application of the LFMP onto the NCM811 particles with >10 wt. % coating mass relative to the overall weight of the coated cathode active material particles. More specifically, 0.3 grams of LFMP (pre-milled to an average (D₅₀) particle size of 0.4 to 0.5 μm and 4.0 grams of NCM811 particles was blended with 20 grams of 0.6 mm size zirconia beads. This blend was rolled at 200 rpm to 300 rpm for 12 hours to form a 1^{st} coating layer on the cathode active material particles. Then, a total of 0.21 grams of LFMP (pre-milled) was added to the mixture containing the 1^{st} coated particles and rolled for another 12 hours in order to apply more of the coating material onto the cathode active material as a 2^{nd} coating layer. Then, the 2^{nd} coated NCM811 particles were used again along with another addition of 0.21 grams of LFMP (pre-milled). This mixture was then rolled a 3rd time to form the coated cathode active material with a coating mass loading of ≥15 wt. % relative to the overall weight of the coated cathode active material.

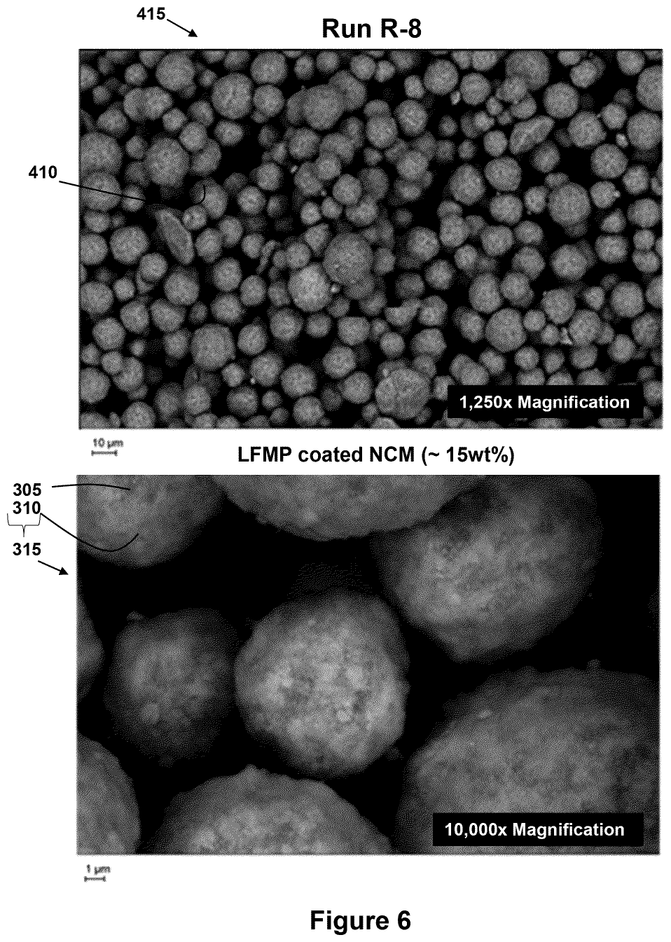

Referring now to FIG. 6, the cathode active material particles 405 were determined to be coated with the coating material 410 to form coated cathode active material particles 415. The coating material 410 was found to provide a uniform coating layer on the cathode active material.

According to another aspect of the present disclosure the dry coating process is capable of coating a phosphate-active material onto polycrystalline NCM particles by controlling the milling speed, the size of the beads, and the particle size of the phosphate-active material. In this sense, both LFP and LFMP is able to be effectively coated in at least 10 wt. %, alternatively, greater than 10 wt. % relative to the overall weight of the coated NCM particles. One skilled in the art will understand that the same concept may also be applied to the coating of other phosphate or non-phosphate materials onto the surface of cathode active materials including carbon materials and/or metal oxides without exceeding the scope of the present disclosure.

Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A process for preparing a coated cathode active material for use in an energy storage device; the process comprising the steps of:
providing at least one coating material, the coating material having an average D₅₀ particle size that is in the range of 0.01 μm to 1.5 μm;
providing one or more cathode active materials;
blending the at least one coating material and the one or more cathode active materials with a plurality of milling beads to form a dry mixture, wherein the milling beads have a bead size ranging from 0.1 mm to 2.0 mm;
rotating the dry mixture at a speed that is in the range of 50 rpm to 800 rpm for one or more hours to form the coated cathode active material; and
separating the coated cathode active material from the milling beads;
wherein the coated cathode active material has an average particle size in the range of 2 μm to 30 μm.

2. The process according to claim 1, wherein the at least one coating material is an electrochemically inert material, the electrochemically inert material being comprised of carbon, an ionic conductive material, or a mixture thereof.

3. The process according to claim 1, wherein the at least one coating material is an electrochemically active material.

4. The process according to claim 3, wherein the electrochemically active material is a phosphate-active material, selected from the group consisting of LifePO₄ (LFP), LiFeₓMn₁₋ₓPO₄ (0<x<1, LFMP), LiMnPO₄ (LMP), and LiVOPO₄.

5. The process according to claim 1, wherein the average (D₅₀) particle size of the at least one coating material is in the range of 0.05 μm to 1 μm.

6. The process according to claim 1, wherein the average (D₅₀) particle size of the at least one coating material is in the range of 0.2 μm to 0.5 μm.

7. The process according to claim 1, wherein the coated cathode active material comprises between 0.1% and 50% by mass of the coating material.

8. The process according to claim 1, wherein the coated cathode active material comprises between 10% and 20% by mass of the coating material.

9. The process according to claim 1, wherein the cathode active material is selected from the group consisting of LiMn₂O₄, LiCoO₂, LiNiO₂, and LiNiO₂-based materials.

10. The process according to claim 1, wherein the cathode active material is selected from the group consisting of NCM523, NCM622, NCM712, NCM811, NCA, NCMA, and NCM90505.

11. The process according to claim 1, wherein the coated cathode active material comprises spherical-like secondary particles.

12. The process according to claim 1, wherein the coated cathode active material has an average particle size in the range of 5 μm to 20 μm.

13. The process according to claim 1, wherein the plurality of milling beads comprise stainless steel, ZrO₂, modified ZrO₂, or a mixture thereof.

14. The process according to claim 1, wherein the plurality of milling beads has an average particle size ranging from 0.5 mm to 1.0 mm.

15. The process according to claim 1, wherein the speed at which the mixture is rotated ranges from 200 rpm to 300 rpm.

16. The process according to claim 1, wherein the time over which the mixture is rotated is in the range from 1 hour to 48 hours.

17. A process for preparing a coated cathode active material for use in an energy storage; the process comprising the steps of:
a) providing at least one coating material, the coating material having an average D₅₀ particle size that is in the range of 0.01 μm to 1.5 μm;
b) providing one or more cathode active materials;
c) blending the at least one coating material and the one or more cathode active materials with a plurality of milling beads having a bead size ranging from 0.1 mm to 2.0 mm to form a dry mixture, wherein the dry mixture comprises 0.1 wt. % to 10 wt. % of the at least one coating material with respect to the combined weight of the at least one coating material and the one or more cathode active materials;
d) rotating the dry mixture at a speed that is in the range of 50 rpm to 800 rpm for one or more hours to form an initial coating on cathode active material;
e) blending an additional predetermined amount of coating material into the dry mixture to form a concentrated dry mixture;
f) repeating step d) with the concentrated dry mixture to form a coated cathode active material comprising >10 wt. % coating material relative to the overall weight of the coated cathode active material; and
g) separating the coated cathode active material from the milling beads;
wherein the coated cathode active material has an average particle size in the range of 2 μm to 30 μm.

18. The process according to claim 17, wherein the at least one coating material is an electrochemically inert material comprised of carbon, an ionic conductive material, or a mixture thereof or the at least one coating material is an electrochemically active material comprised of a phosphate-active material selected from the group consisting of LifePO₄ (LFP), LiFeₓMn₁₋ₓPO₄ (0<x<1, LFMP), LiMnPO₄ (LMP), and LiVOPO₄.

19. The process according to claim 17, wherein one or more of the following is present:
the cathode active material is selected from the group consisting of LiMn₂O₄, LiCoO₂, LiNiO₂, and LiNiO₂-based materials;
the cathode active material is selected from the group consisting of NCM523, NCM622, NCM712, NCM811, NCA, NCMA, and NCM90505;
the coated cathode active material comprises spherical-like secondary particles; and
the plurality of milling beads comprise stainless steel, ZrO₂, modified ZrO₂, or a mixture thereof.

20. A process for forming an energy storage device, the process comprising the following steps:
preparing a coated cathode active material using a dry coating process according to claim 1; and
incorporating the coated cathode active material into the energy storage device.
